(19) United States
(12) Patent Application Publication
(10) Pub. No.: US 2007/0295659 A1
(43) Pub. Date: Dec. 27, 2007

(54) Filters and methods of manufacturing the same

(75) Inventors: James W. M. Rygalski, Lancaster, PA (US); John C. Sellars, Wauwatosa, WI (US); William R. Sellars, Milwaukee, WI (US); Thomas C. Shutt, Milwaukee, WI (US); Richard J. Goepel, Sussex, WI (US)

Correspondence Address: MICHAEL BEST & FRIEDRICH LLP, 100 E WISCONSIN AVENUE, Suite 3300, MILWAUKEE, WI, 53202, US

(73) Assignee: Sellars Absorbent Materials, Inc., Milwaukee, WI (US)

(21) Appl. No.: 11/789,187

(22) Filed: Apr. 23, 2007

Related U.S. Application Data
(63) Continuation-in-part of application No. 11/238,746, filed on Sep. 29, 2005.

(51) Int. Cl. B01D 39/18; B27N 1/02; B27N 3/00; B27N 3/14

(52) U.S. Cl. 210/504; 156/62.4

(57) ABSTRACT

A filter and methods of manufacturing the same. In one embodiment, the filter includes a first scrim made from at least one thermoplastic material; a second scrim made from at least one thermoplastic material; and a middle layer positioned between the first and second scrims. The middle layer includes a dry-laid web of cellulose and opened, individuated staple bicomponent fiber. At least some of the bicomponent fiber in the middle layer is thermally bonded to at least some of the cellulose in the middle layer, and the first and second scrims are thermally bonded to the middle layer.

### RELATED APPLICATION

This patent application is a continuation-in-part of prior application Ser. No. 11/238,746, filed on Oct. 4, 2006.

### BACKGROUND

Embodiments of the invention relate to non-woven materials and, more particularly, to certain types of non-woven materials which are used for filtration purposes.

Filters can be used in a variety of situations. For example, filters can be used to filter liquids (such as water) as well as gases (such as air). Depending on the application, filters can be manufactured with different materials.

### SUMMARY

Although current filters are found in a wide range of applications, filters with improved characteristics such as increased efficiency and lower cost would be beneficial. Efficiency of the filter is often dependent on the particle retention ratio of the filtration material. One embodiment of the invention includes a filter made mostly from cellulose. The cellulose is processed in such a manner that allows the filter to have improved efficiency in filtering gaseous and liquid fluids with respect to other known filtration materials.

Another benefit of using cellulose is decreased costs. Some current filters are made largely from synthetic or petroleum-derived materials. Currently, it appears that the costs of petroleum-based products will continue to rise. Thus, reducing the amount of petroleum-based components in the filtration media can help to control costs. In addition, petroleum is considered to be a non-renewable resource. Thus, reducing the amount of petroleum-based components helps reduce dependency on non-renewable resources.

In some instances, cellulose is considered to pose higher fire risks than certain synthetic materials that may be used in current filters. However, the cellulose used in certain embodiments of the invention is treated with a fire retardant to ensure that the end product has a fire retardancy that is equivalent to or better than current materials used in some filters.

Another benefit of certain embodiments of the invention is that recycled cellulose may be used. In many instances, recycled cellulose is available at relatively low cost. Thus, the overall cost of the end product is reduced. In addition, the use of recycled cellulose material may have environmental benefits.

In one embodiment the invention provides a filter. The filter includes a top scrim made from at least one thermoplastic material, a bottom scrim made from at least one thermoplastic material, and a middle layer positioned between the top and bottom scrims. The middle layer includes a dry-laid web of cellulose and opened, individuated, staple bicomponent fiber. At least some of the bicomponent fiber in the middle layer is thermally bonded to at least some of the cellulose in the middle layer. In addition, the first and second scrims are thermally bonded to the middle layer.

Another embodiment of the invention provides a method of manufacturing a filtration material. The method includes obtaining at least one type of cellulose from a group of cellulose sources including a source of virgin cellulose, a source of post-industrial cellulose, and a source of post-consumer cellulose, shredding the cellulose, and declumping and sizing the cellulose. The cellulose is metered into a spray booth where one or more additives may be applied to the cellulose. The additives can be selected from the group of a debonder and a fire retardant. The method may also include drying the cellulose; declumping and sizing the cellulose, fiberizing the cellulose, or both; metering the cellulose into a forming head; metering bicomponent fiber into the forming head; and forming a non-woven web of the cellulose and bicomponent fiber on a forming wire positioned below the forming head. The web is sandwiched between a first scrim and a second scrim to form a non-woven web. The non-woven web is then heated in an oven to cause an outer layer of the bicomponent fiber to melt. The molten material contacts other fiber and when re-hardened or cooled creates bonds between at least some of the bicomponent fiber and the cellulose. The heating process also causes at least a portion of the first and second scrims to bond with the non-woven web. After the non-woven web has been formed and cooled, it is then wound onto a parent roll in a continuous process. These rolls are then taken to a converting process where they are either cut into pads, die cut into specific shapes and sizes, or converted into smaller rolls. It is also possible to replace the parent roll winder with an in-line sheeter to cut the non-woven web into pads as part of a continuous process.

Other aspects and embodiments of the invention will become apparent by consideration of the detailed description and accompanying drawings.

### BRIEF DESCRIPTION OF THE DRAWINGS

FIG. 1 is a perspective, partially exploded view of a filtration material.

FIG. 2 is a flow chart illustrating a portion of a process for making a filtration material.

FIG. 3 is a flow chart illustrating another portion of a process for making a filtration material.

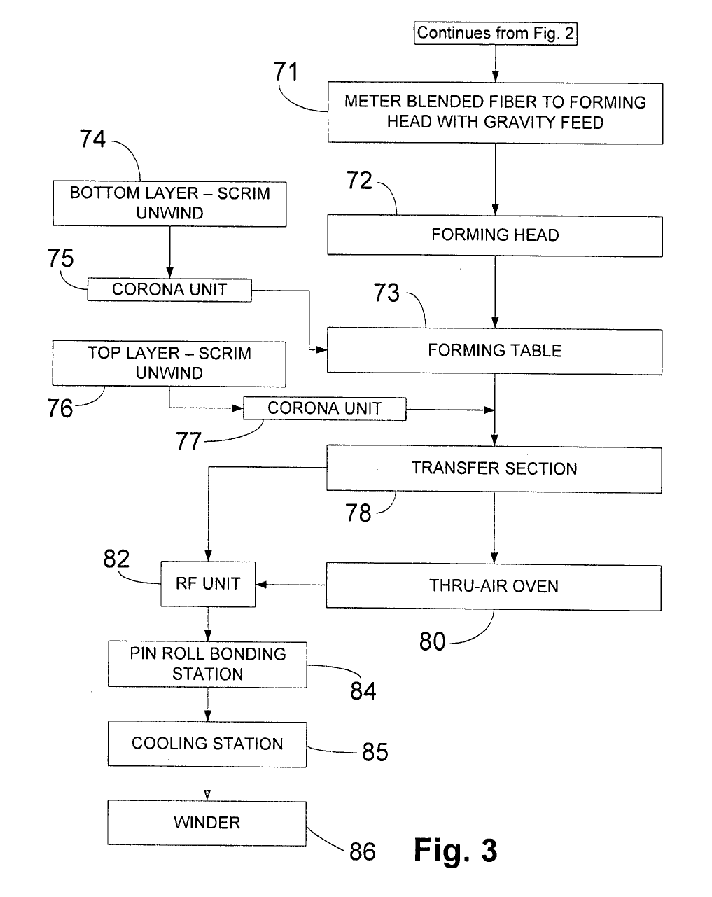

FIG. 4 is a flow chart illustrating another portion of a process for making a filtration material.

FIG. 5 illustrates a table and a graph indicating test results of a filtration material.

FIG. 6 illustrates another table and another graph indicating test results of a filtration media.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

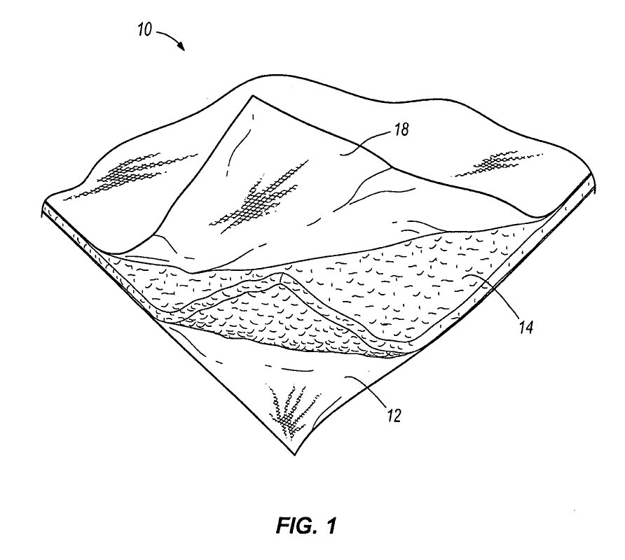

FIG. 1 illustrates a pad 10 that can be used as a filtration material. The pad 10 has a first, non-woven scrim 12, which may be made from one or more thermo-plastic materials such as polyethylene, polypropylene, and polyester, or a synthetic cellulose-based material such as rayon. In one embodiment, the scrim 12 is made from spunbond, bicomponent material or fibers. In one common form, bicomponent fibers include an inner core of polypropylene and a sheath or outer layer of polyethylene. The outer sheath of polyethylene has a lower melting point than the core of polypropylene. As will be discussed in greater detail below, the scrim 12 is used as an outer layer for the pad 10 to help increase the tensile strength of the pad 10 and to protect a middle layer 14 of dry-laid material. One way in which the scrim 12 helps protect the middle layer 14 is by preventing or reducing Tinting of the middle layer.

In one embodiment, the scrim 12 is fixed to the middle layer 14 by thermal bonds. In this instance, the scrim 12 is heated such that the polyethylene in the bicomponent fibers melts and comes into contact with fibers from the middle layer 14. The pad 10 is then cooled (or allowed to cool) so that the polyethylene re-hardens or cools to form bonding points between at least some of the bicomponent fibers in the scrim 12 and the fibers within the middle layer 14.

The middle layer 14 is, in at least one embodiment, comprised of cellulose or cellulose fibers and staple bicomponent fibers. In a preferred embodiment, the middle layer 14 includes about 90% cellulose and about 10% staple bicomponent fibers by weight. The cellulose can be obtained from a number of different sources including virgin cellulose, post-industrial cellulose (for example, scrap from a paper making facility), and post-consumer cellulose (for example, paper and similar materials recycled by individuals).

The pad 10 also includes a second, non-woven scrim 18. The second scrim 18 may be identical to the first scrim 12 and serves a similar purpose as the scrim 12. The second scrim 18 is fixed to the middle layer 14 in a manner similar to how the first scrim 12 is fixed to the middle layer 14.

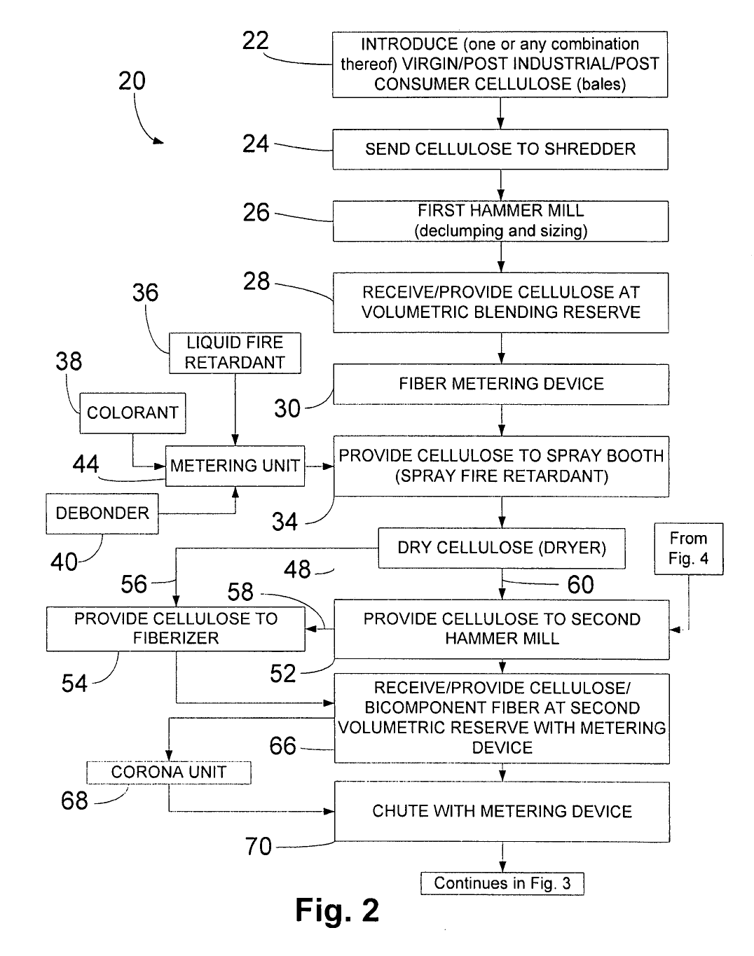

FIG. 2 illustrates a process 20 for making the pad 10. The process 20 begins at step or block 22 in which cellulose from a variety of sources, including those described above, is obtained. Prior to being formed (along with bicomponent fiber) into the middle layer 14, the cellulose undergoes a number of processing steps. First, the cellulose is processed (i.e., shredded) in a shredder (block 24) and then declumped and sized in a first hammer mill (block 26). The processed cellulose may then be delivered to a reserve (block 28) to help ensure proper operation of downstream processes. In particular, a reserve may be used to help ensure that material is supplied to downstream processes at a constant or controlled rate.

The cellulose is then provided to a metering device (block 30) to help ensure the delivery of proper amounts of cellulose to downstream processes. In the embodiment shown, the cellulose is metered into a spray booth or similar device (block 34) (generically, an inline treatment process). A variety of liquid and dry additives may be added to the cellulose in the spray booth (or other treatment device) including fire retardants 36, colorants 38, colorant fixants, and debonders 40. The debonder (which may sometimes be a surfactant) diminishes and inhibits the formation of hydrogen bonds, which allows the fibers to be more fully opened thereby increasing the filtration capacity of the end product.

In the embodiment shown in FIG. 2, the additives are metered into the spray booth through a metering unit (block 44). One manner of applying fire retardant and additives to the cellulose that may be useful in embodiments of the present invention is described in U.S. Pat. No. 5,534,301, which has a common inventor with the present application.

After being treated in the spray booth, the cellulose is dried in a dryer (block 48). The dried cellulose is then provided to a second hammer mill, a fiberizer, or both as shown by blocks 52 and 54 and directional paths 56, 58, and 60. The hammer mill is useful for breaking up the cellulose into small pieces and the fiberizer is useful for individuating the fibers to increase the bulk-to-weight ratio. Thus, one purpose of the post-drying process is to break up clumps of cellulose that may have been formed when the cellulose is in the spray booth. In addition, the post-drying process helps individuate the cellulose fibers before the cellulose is delivered to a forming head (discussed below).

After the cellulose is processed in the second hammer mill, the fiberizer, or both, the cellulose is provided to a forming head of a dry-laid or air-laid device. Before being sent to the forming head, the cellulose may be provided to a second volumetric reserve (block 66) to control the rate of delivery of material. In addition, the cellulose, the bicomponent fiber, or both may be passed through a corona unit, which acts to electrically charge the cellulose and bicomponent fibers, as applicable (block 68). Electrically charging the bicomponent and cellulose fiber can help in increasing tensile strength of the non-woven web, for example, causing the fibers to hold onto or be attracted to other materials. Once appropriately processed, the cellulose is provided via an air stream to a chute with a metering device on top of the forming head (block 70). The cellulose is then meter blended and introduced utilizing gravity and without air to the forming head (block 71). However, alternative embodiments include entraining the cellulose via an air stream into the forming head. As the cellulose travels through ducts to the chute and into the forming head, the individuated cellulose fibers may reform into clumps. The forming head breaks up these clumps of cellulose (block 72) and deposits the cellulose fibers on a wire or conveyor (often referred to as a forming table) (block 73). The first scrim 12 is unwound (block 74) so that it may be provided to the forming table in a manner such that an air-laid web is formed on top of the scrim 12. If desired, the first scrim 12 may be processed in a corona unit (block 75) before it reaches the forming table. Processing the scrim 12 in the corona unit helps to increase adhesion of the scrim 12 to the layer 14. As will be discussed later, the cellulose forms a mixture with bicomponent fiber in a section upstream of the forming head. The mixture is then provided to the forming head via gravity without air with a metering device, the chute being above the forming head. Thus, the air-laid web (or middle layer 14) formed on the forming table includes a mixture of cellulose fibers (processed and treated as described above) and bicomponent fiber (processed as described below).

After the web is formed on the first scrim 12, the second scrim 18 is applied to the top of the web. In particular, the scrim 18 may be unwound (block 76), processed in a corona unit (block 77), and placed on top of the web formed on the forming table. Once the three layers of the pad 10 have been positioned correctly with respect to one another, the scrims 12 and 18 and the middle layer 14 can be bonded together. In addition, the cellulose material in the middle layer 14 may be bonded together. In one embodiment, the non-woven web 10 is passed through a transfer station (block 78) and subsequently through an oven, which can take the form of a conventional thermal oven or a radio frequency (“RF”) or microwave oven (blocks 80 and 82). While in the oven, the bicomponent fibers in the scrims 12 and 18 and the bicomponent fibers in middle layer 14 melt. As a consequence, thermal bonds are formed between the scrims 12 and 18 and the middle layer 14 and within the middle layer 14. (The bonds are formed in a manner as was described above with respect to scrim 12). After being heated in the oven, the non-woven web 10 may be processed in a pin roll bonding station, if desired (block 84). A pin roll creates dimples in the non-woven web 10 and these dimples help to mechanically hold the layers of the non-woven web 10 together. The pin roll station may include one or more pin rolls.

Once the pad 10 is bonded and optionally dimpled, it may be wound on a winder (block 86). Rolls of pad material may be converted in a separate process such that the pad material is cut to desired sizes and packaged in containers suitably designed to enable easy dispensing of individual pads by end users. Alternatively, the pad material may be wound on smaller rolls or cut, inline, into pads suitable for sale to end users.

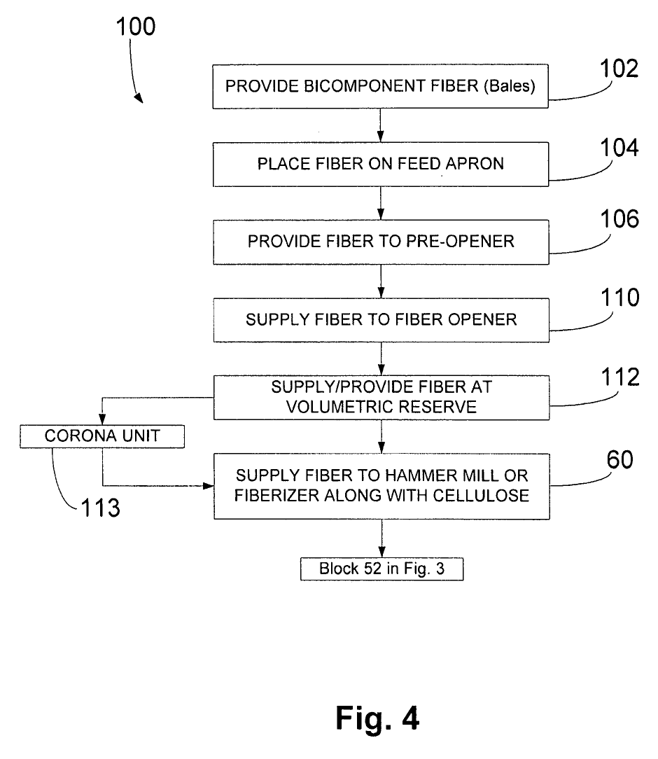

As noted, bicomponent fiber is provided to the forming head. In one embodiment, the bicomponent fibers are staple bicomponent fibers. In certain embodiments fibers of about 1 to 10 denier (thickness) and lengths of about ⅛″ to about 4″ can be used. FIG. 4 illustrates a process 100 by which bicomponent fiber is processed and supplied to a hammer mill as described in block 52. First, bulk bicomponent fiber (usually in the form of bales) (block 102) is supplied to a feed apron (block 104). Prior to supplying the bales to the feed apron, the straps or wires holding the bales are removed. The feed apron moves the bales of bicomponent fiber to a pre-opener (block 106). The pre-opener breaks the bails into pieces and transfers metered amounts of bicomponent fibers to an opener (block 110). The opener breaks apart the pieces of bicomponent material so as to open and individuate the fibers. If desired the individuated fibers may be transferred to a volumetric reserve (block 112) to help control the rate of fiber delivery to downstream processes. In addition, the bicomponent fiber may also be passed through a corona unit (block 113). Fiber is then transported to the second hammer mill or fiberizer along with cellulose, which is described as block 52 in FIG. 2. As described above, an air- or dry-laid web of cellulose and bicomponent fibers is created by the forming head. A forming head suitable for use in making the pad 10 is described in U.S. patent application Ser. No. 11/296,125, which is owned by the same assignee of the present application.

If desired, the bicomponent fiber may be treated with a surfactant. When so treated, the bicomponent fiber becomes hydrophilic. The surfactant also helps to increase bulk and absorbency.

What has been described with respect to process 20 and process 100 involves the use of separate chutes to deliver fibers to a forming head: a first chute provides cellulose fibers to the forming head and a second chute provides bicomponent fibers to the forming head. In this particular case, cellulose fibers and bicomponent fibers are fed to the forming head via a venture effect. In other embodiments, a single chute is used to receive cellulose and bicomponent fiber. The chute is generally placed on top of the forming head. The mixture of cellulose and bicomponent fiber is fed to the forming head with a metering device via gravity without the use of air.

With reference to FIG. 1, the pad 10 includes the non-woven scrims 12 and 18 with a middle layer 14 forming a tri-layer filtration material or pad. In some constructions, the manufacturing process of the tri-layer filtration pad can include reducing the permeability of at least one of the non-woven scrims 12 and 18. For example, the manufacturing process can include reducing the permeability of one non-woven scrim 12, 18 that is placed downstream from the other non-woven scrim 12, 18 with respect to the flow of filtered fluid. Reducing the permeability of at least one of the non-woven scrims 12 and 18 allows the tri-layer filtration material to improve the retention of particles in the media that the tri-layer material is intended to filter. In other constructions, the pad 10 can include a first layer, similar to one non-woven scrim 12, 18, and a second layer, similar to the middle layer 14, thus forming a dual-layer filtration material or pad. The dual-layer filtration pad has the advantage of decreasing the impedance or flow resistance for a media intended to be filtered with the dual-layer filtration pad.

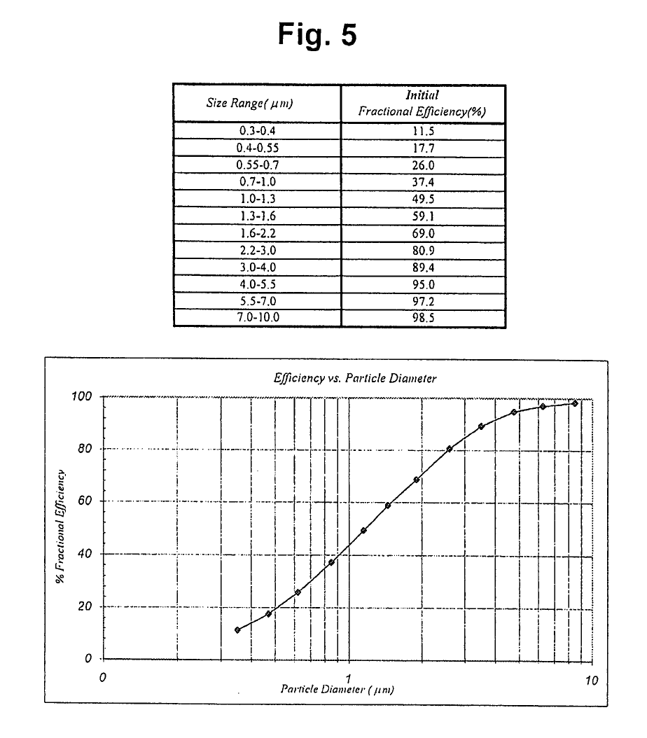

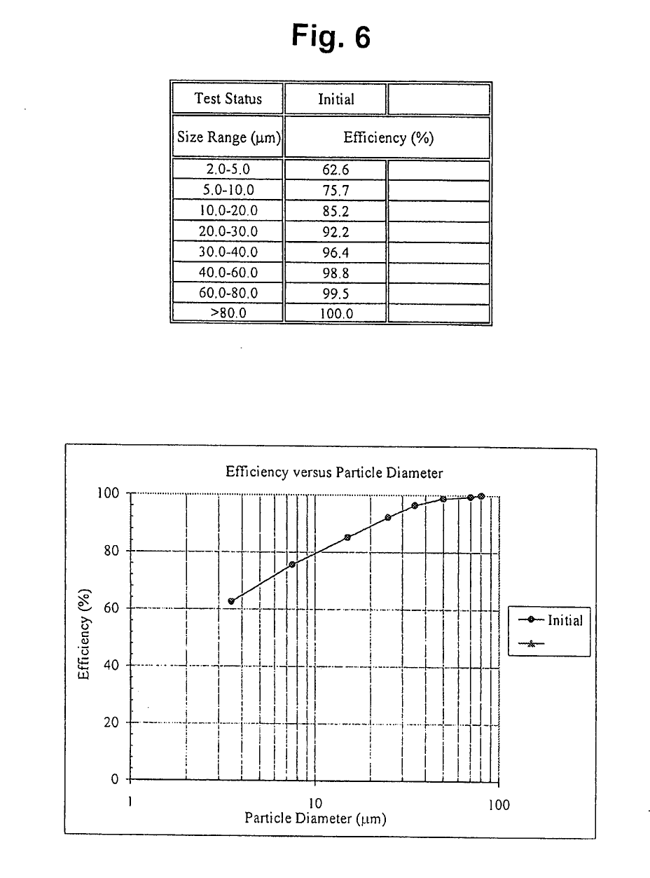

A pad 10 used as a filtration device was tested to determine the filtration efficiency. In one type of test, the pad 10 was tested as a gaseous fluid filter to determine fractional efficiency of the pad 10. FIG. 5 illustrates a chart and graph indicating the fractional efficiency of the pad 10 as a function of particle size. The test indicates that for particles larger than 2.2 microns (μm), the pad 10 exhibits an efficiency of above 80%. Moreover, the filtering efficiency of the pad 10 for this type of testing is greater by at least 18% with reference to other materials. In another type of test, the pad 10 was tested as a liquid fluid filter to determine efficiency of the pad 10. In particular, this test uses latex beads of at least 2 μm in a liquid media filtrated to through the pad 10. FIG. 6 illustrates a chart and graph indicating the efficiency of the pad 10 as a function of particle size. The test indicates that for particles larger than 20 μm, the pad 10 exhibits an efficiency of above 92%. In the particular test where the pad 10 is used as a liquid fluid filter, efficiency is determined according to equation (e1):

$${F}_{eff} = \frac{{C}_{up} - {C}_{down}}{{C}_{up}} \times 100 \% \qquad ( e 1 )$$

Where F_{eff} is % efficiency, Cᵤₚ is particle concentration upstream of the pad 10, and C_{down} is particle concentration downstream of the pad 10.

As should be apparent from the above, embodiments of the invention provide, among other things, a filter and methods of manufacturing filtration or filter material. Various features, advantages, and embodiments of the invention are set forth in the following claims.

What is claimed is:

1. A filter comprising:
a first scrim made of a synthetic material;
a second scrim made from a synthetic material; and
a middle layer positioned between the first and second scrims, the middle layer having a dry-laid web of cellulose and opened, individuated staple bicomponent fiber,
wherein at least some of the bicomponent fiber in the middle layer is thermally bonded to at least some of the cellulose in the middle layer, and at least the first and second scrims are bonded to the middle layer.

2. A filter as claimed in claim 1, wherein the middle layer further includes a dry-laid web of fire-retardant treated cellulose.

3. A filter as claimed in claim 2, wherein the fire-retardant treated cellulose includes cellulose treated with a debonder.

4. A filter as claimed in claims 2 or 3, wherein the first and second scrims include spunbond, bicomponent material.

5. A filter as claimed in claim 1, wherein the cellulose includes cellulose treated with a debonder.

6. A filter as claimed in claim 5, wherein the first and second scrims include spunbond, bicomponent material.

7. A filter as claimed in claim 1, wherein the middle layer includes a mixture of about 90% of cellulose and about 10% of bicomponent fiber, by weight.

8. A filter as claimed in claim 1, wherein the middle layer has a bulk-to-weight ratio of about 10 to about 30.

9. A filter as claimed in claim 1, wherein the cellulose further includes recycled cellulose.

12. A method as claimed in claim 10, wherein heating the pad in an oven includes heating the pad in an RF unit.

13. A method as claimed in claim 10, wherein heating the pad in an oven includes heating the pad in a thermal oven.

14. A method as claimed in claim 10, further comprising processing the cellulose in a corona unit prior to metering the cellulose into a forming head.

15. A method as claimed in claim 10, further comprising processing the bicomponent staple fiber in a corona unit prior to metering the bicomponent fiber into a forming head.

14. A method as claimed in claim 10, further comprising processing the first scrim in a corona unit prior to sandwiching the web of the cellulose and bicomponent fiber.

15. A method as claimed in claim 10, further comprising placing the first scrim on the forming wire and forming a web of the cellulose and bicomponent fiber on the first scrim.

16. A method as claimed in claim 10, further comprising processing the second scrim in a corona unit prior to sandwiching the web of the cellulose and bicomponent fiber.

17. A method as claimed in claim 10, further comprising processing the pad in a pin roll station after heating the pad in an oven.

18. A method as claimed in claim 10, wherein metering the cellulose into a forming head and metering bicomponent fiber into the forming head include entraining the cellulose and bicomponent fiber via a venturi effect in to a single chute.

19. A method as claimed in claim 10, wherein metering the cellulose into a forming head includes entraining the cellulose via an air stream into a first chute and metering bicomponent fiber into the forming head include entraining the bicomponent fiber via an air stream into a second chute.

20. A method as claimed in claim 10, further comprising treating the cellulose with a debonder, a surfactant, or both.

10. A method of manufacturing a filtration material, the method comprising:
obtaining at least one type of cellulose from a group of cellulose sources including a source of virgin cellulose, a source of post-industrial cellulose, and a source of post-consumer cellulose;
shredding the cellulose;
declumping and sizing the cellulose;
metering the cellulose into a spray booth;
applying at least one additive to the cellulose in the spray booth, the at least one additive selected from the group of a debonder and a fire retardant;
if the at least one additive is a liquid, drying the cellulose;
declumping and sizing the cellulose, fiberizing the cellulose, or both;
metering the cellulose into a forming head;
metering bicomponent fiber into the forming head;
forming a web of the cellulose and bicomponent fiber on a forming wire positioned below the forming head;
sandwiching the web between a first scrim and a second scrim to form a pad; and
heating the pad in an oven to cause an outer layer of the bicomponent fiber to melt to bond at least some of the bicomponent fiber to at least some of the cellulose and to cause at least a portion of the first and second scrims to bond with the web.

11. A method as claimed in claim 10, further comprising milling the cellulose to individuate cellulose fibers.

21. A method of manufacturing a filtration material, the method comprising:
obtaining at least one type of cellulose from a group of cellulose sources including a source of virgin cellulose, a source of post-industrial cellulose, and a source of post-consumer cellulose;
shredding the cellulose;
declumping and sizing the cellulose;
applying at least one liquid additive to the cellulose, the at least one liquid additive selected from the group of a debonder and a fire retardant;
drying the cellulose;
individuating the cellulose, the bicomponent fiber, or both;
supplying the cellulose and bicomponent fiber to a forming head;
forming a web of the cellulose and bicomponent fiber on a forming wire positioned below the forming head;
sandwiching the web between a first scrim and a second scrim to form a pad; and
heating the pad in an oven to cause an outer layer of the bicomponent fiber to melt to bond at least some of the bicomponent fiber to at least some of the cellulose and to cause at least a portion of the first and second scrims to bond with the web.

22. A method of manufacturing a filtration material, the method comprising:
obtaining at least one type of cellulose from a group of cellulose sources including a source of virgin cellulose, a source of post-industrial cellulose, and a source of post-consumer cellulose;
shredding the cellulose;
declumping and sizing the cellulose;
metering the cellulose into a spray booth;
applying at least one additive to the cellulose in the spray booth, the at least one additive selected from the group of a debonder and a fire retardant;
if the at least one additive is a liquid, drying the cellulose;
declumping and sizing the cellulose, fiberizing the cellulose, or both;
entraining the cellulose via a venturi effect into a forming head;
entraining bicomponent fiber via a venturi effect into the forming head;
forming a web of the cellulose and bicomponent fiber on a forming wire positioned below the forming head;
sandwiching the web between a first scrim and a second scrim to form a pad; and
heating the pad in an oven to cause an outer layer of the bicomponent fiber to melt to bond at least some of the bicomponent fiber to at least some of the cellulose and to cause at least a portion of the first and second scrims to bond with the web.

23. A method of manufacturing a filtration material, the method comprising:
obtaining at least one type of cellulose from a group of cellulose sources including a source of virgin cellulose, a source of post-industrial cellulose, and a source of post-consumer cellulose;
shredding the cellulose;
declumping and sizing the cellulose;
metering the cellulose into a spray booth;
applying at least one additive to the cellulose in the spray booth, the at least one additive selected from the group of a debonder and a fire retardant;
if the at least one additive is a liquid, drying the cellulose;
declumping and sizing the cellulose, fiberizing the cellulose, or both;
creating a mixture of bicomponent fiber to the cellulose;
providing the mixture to a chute, wherein the chute is placed above a forming head;
supplying the mixture to the forming head via gravity without air with a metering device at least partially within the chute;
forming a web of the cellulose and bicomponent fiber on a forming wire positioned below the forming head;
sandwiching the web between a first scrim and a second scrim to form a pad; and
heating the pad in an oven to cause an outer layer of the bicomponent fiber to melt to bond at least some of the bicomponent fiber to at least some of the cellulose and to cause at least a portion of the first and second scrims to bond with the web.
